(19) United States
(12) Patent Application Publication
(10) Pub. No.: US 2007/0273778 A1
(43) Pub. Date: Nov. 29, 2007

(54) PHOTO SENSING DISPLAY APPARATUS AND DISPLAY PANEL THEREOF

(75) Inventors: Ching-Fu Hsu, Taichung County (TW); Shin-Tai Lo, Miaoli County (TW); Wan-Jen Tsai, Taichung County (TW); Chun-Chi Chi, Taichung County (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: WINTEK CORPORATION, Taichung (TW)

(21) Appl. No.: 11/739,119

(22) Filed: Apr. 24, 2007

(30) Foreign Application Priority Data
May 25, 2006 (TW) 95118654

(51) Int. Cl. H04N 5/335

(52) U.S. Cl. 348/294; 345/87; 348/E05.031

(57) ABSTRACT

A photo sensing display apparatus includes a display panel and a photo sensing controller. The display panel includes an active area, an inactive area, a number of sub-pixels and at least a dummy sub-pixel. The inactive area disposed around the active area. The sub-pixels are disposed in the active area for displaying a frame. The dummy sub-pixel is disposed in the active area and has a photo sensing device. The photo sensing controller is coupled to the photo sensing device.

This application claims the benefit of Taiwan application Serial No. 95118654, filed May 25, 2006, the subject matter of which is incorporated herein by reference.

### BACKGROUND OF THE INVENTION

1. Field of the Invention

The invention relates in general to a display apparatus and display panel thereof, and more particularly to a photo sensing display apparatus, which senses environmental luminance by dummy sub-pixels, and display panel thereof.

2. Description of the Related Art

Environmental luminance has usually significant influence on the display effect of a display apparatus. For example, under a bright environmental light source, the display frame becomes brighter, while in a dim environment, ripples will be occurred on the display frame. Too bright images will result in easy tiredness of the observer' eyes while dark images have obvious black-color fluctuation, which greatly lowers down image contrast. Besides, the darker images cannot provide a satisfied colorful effect. Therefore, the display apparatus normally has an additional photo sensing device for detecting the environmental luminance and accordingly adjusting image brightness to improve viewing comfort of the users.

In a U.S. Pat. No. 5,831,693, it discloses that a number of photo sensing devices are respectively disposed at four corners of an inactive area (VA) of a display panel and photoelectric currents outputted by the photo sensing devices have to be amplified via an operational amplification circuit of the display apparatus system. For this reason, system complication and cost will be increased. Moreover, the openings required for the photo sensing devices occupy a large area of the area VA, and largely influence artistic appearance of the display apparatus.

Besides, a Taiwan patent No. TW575849 discloses an adjustable thin film transistor (TFT) liquid crystal display, which uses at least a TFT disposed around a lower substrate as a photo sensing device to detect the environmental luminance. The liquid crystal display is very similar to the design of the U.S. Pat. No. 5,831,693 and also encounters the above-mentioned issues.

That is, the U.S. Pat. No. 5,831,693 and Taiwan patent No. TW575849 both have issues of an overlarge edge of panel, an overlarge and complicated circuit layout, reduction of artistic appearance due to an overlarge opening area and an incomplete light-receiving angle due to dot-like arrangement.

In additions, in a Japanese patent No. 11-125841, each sub-pixel has two TFTs, one of which is for frame display and the other is for transmitting a photo-data current after illumination. Disposition of a photo sensing device in each sub-pixel will complicate layout of the sub-pixels in the active area and reduce an aperture rate of the panel, and deposition of a photoelectric semiconductor on a TFT substrate in manufacturing of the display panel will increase process complication and production cost. Each photo sensing device disposed in a sub-pixel used for frame display of the active area is connected via a control signal line to an external region of the active area for control, which easily reduces an aperture ratio of the sub-pixels for frame display and increases layout complication of the active area.

### SUMMARY OF THE INVENTION

It is therefore an object of the invention to provide a photo sensing display apparatus and a display panel thereof. The photo sensing device is disposed in a dummy sub-pixel of the active area, which can prevent reduction of artistic appearance of the display panel due to an overlarge opening area. In addition, the photo sensing device of the invention can increase the capability of receiving incident light form different direction. In other words, the photo sensing display apparatus has a more complete light receiving angle and thus effectively improves light sensing efficiency.

The invention achieves the above-identified object by providing a photo sensing display apparatus including a display panel and a photo sensing controller. The display panel includes an active area, an inactive area, a number of sub-pixels and at least a dummy sub-pixel. The inactive area disposed around the active area. The sub-pixels are disposed in the active area for displaying a frame. The dummy sub-pixel is disposed in the active area and has a photo sensing device. The photo sensing controller is coupled to the photo sensing device.

The invention achieves the above-identified object by providing a display panel capable of sensing environmental luminance and electrically coupled to a photo sensing controller. The display panel includes an active area, an inactive area, a number of sub-pixels and at least a dummy sub-pixel. The inactive area is disposed around the active area. The sub-pixels are disposed in the active area for displaying a frame. The dummy sub-pixel is disposed in the active area and has a photo sensing device for sensing the environmental luminance and outputting a photo sensing signal to the photo sensing controller.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a schematic diagram of a photo sensing display apparatus according to a preferred embodiment of the invention.

FIG. 2A is a schematic diagram of configuration of dummy sub-pixels in a display panel of FIG. 1.

FIGS. 2B˜2D are schematic diagrams of another examples of signal control of the dummy sub-pixels on the display panel of FIG. 1.

FIG. 3 is a relationship diagram of illumination intensity and photoelectric current.

### DETAILED DESCRIPTION OF THE INVENTION

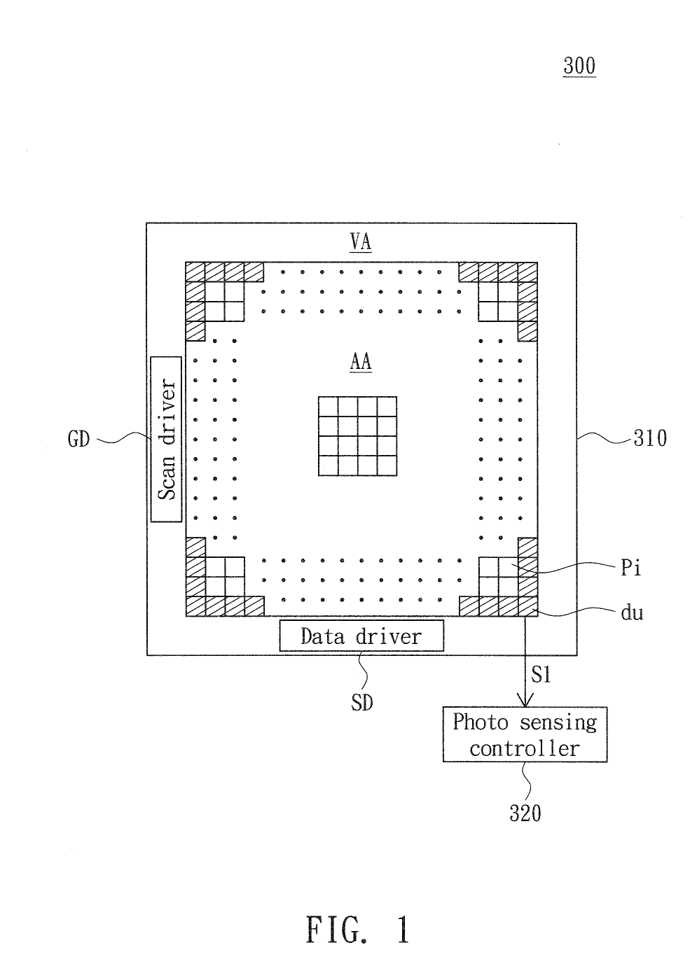

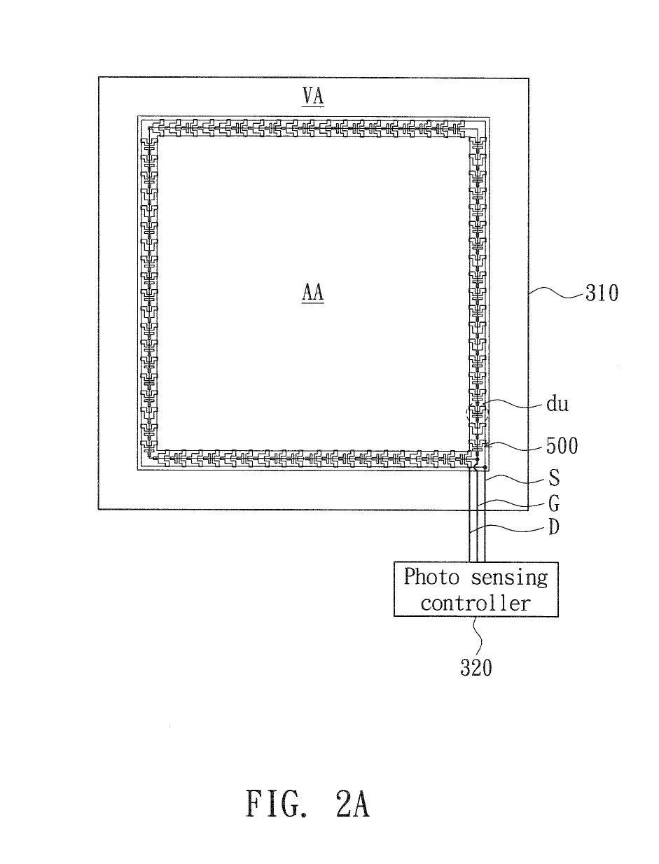

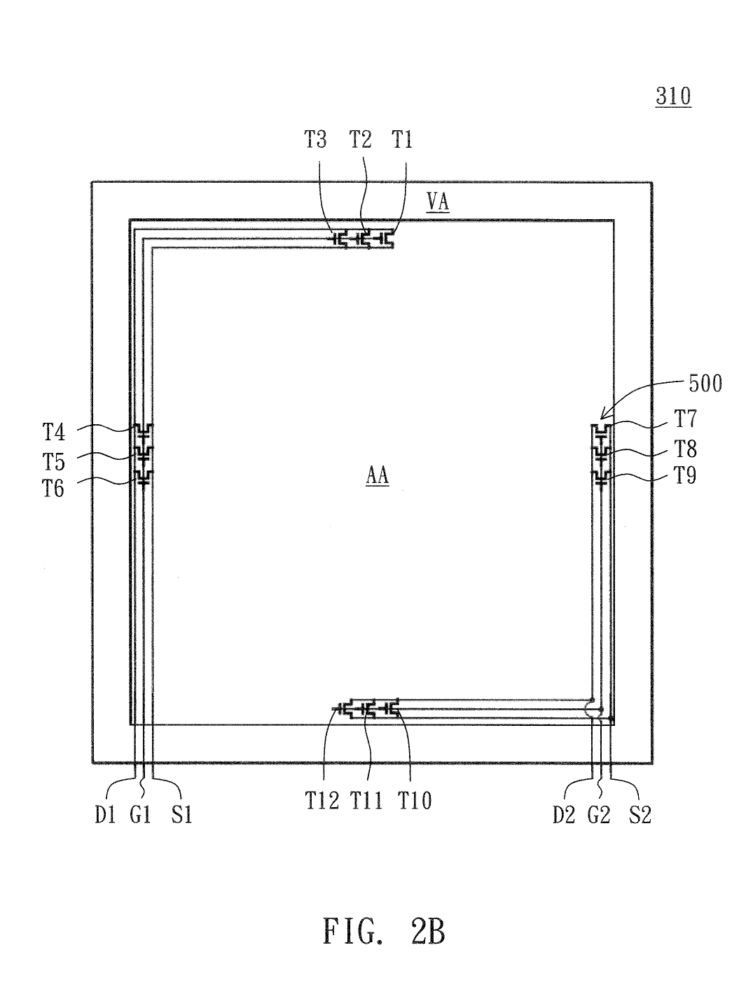

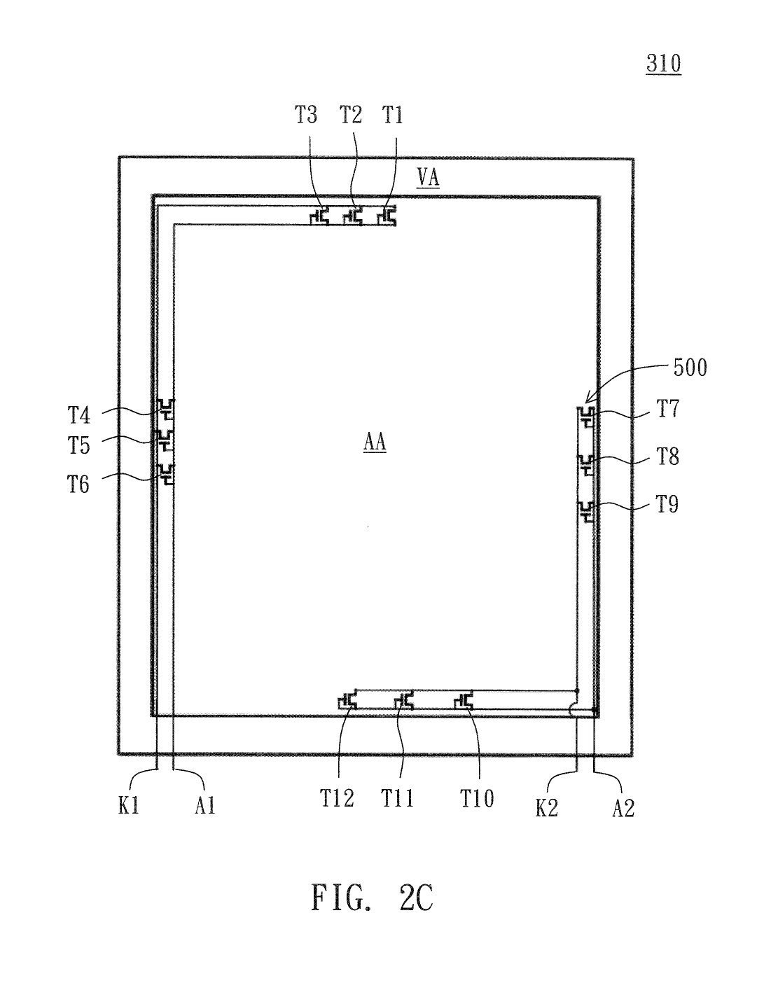

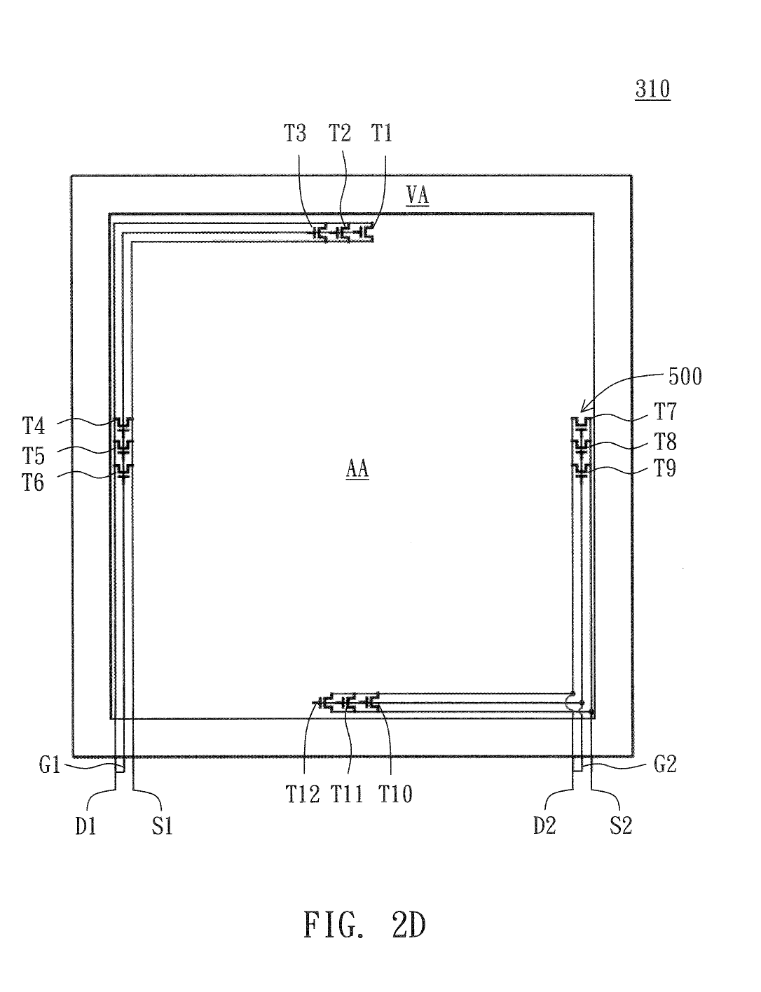

Referring to FIG. 1 and FIG. 2A, a schematic diagram of a photo sensing display apparatus according to a preferred embodiment of the invention and a schematic diagram of configuration of dummy sub-pixels in a display panel of FIG. 1 are shown respectively. As shown in FIG. 1 and FIG. 2A, a photo sensing display apparatus 300 includes a display panel 310 and a photo sensing controller 320. The display panel 310 includes an active area AA, an inactive area VA, a number of sub-pixels pi and at least a dummy sub-pixel du. It is exemplified that a number of dummy sub-pixels du are disposed in the display panel 310 in the embodiment. The inactive area VA is disposed around the active area AA. The sub-pixels pi are disposed in the active area AA for displaying a frame. Each dummy sub-pixel du has a photo sensing device 500 for detecting an environmental luminance and accordingly outputting a photo sensing signal S1. A data driver SD and a scan driver GD are disposed in the inactive area VA for controlling the sub-pixels pi to display the frame.

For the second time, referring to FIG. 1 and FIG. 2A, The photo sensing controller 320 is coupled to the photo sensing device 500 of each dummy sub-pixel du and receives the photo sensing signal S1 for, such as, adjusting luminance of a light source of a backlight module. The photo sensing device 500 of each dummy sub-pixel du can have many ways to connect with the photo sensing controller 320. In the embodiment, the photo sensing devices 500 are coupled to each other in series and electrically coupled to the photo sensing controller 320. For example, the photo sensing device 500 of each dummy sub-pixel du is composed of a TFT and the gate of each TFT is connected to the photo sensing controller 320 via a control line G. The source of each TFT is connected to the photo sensing controller 320 via a control line S and the drain of each TFT is connected to the photo sensing controller 320 via a control line D.

Referring to FIG. 2B, a schematic diagram of another example of signal control of the dummy sub-pixels du on the display panel 310 of FIG. 1 is shown. The photo sensing device 500 of each dummy sub-pixel du is a TFT for instance. The photo sensing devices 500 are divided into a number of groups. Each group of photo sensing devices 500 have their gates coupled to each other via a first control line, their drains coupled to each other via a second control line and their sources coupled to each other via a third control line. For example, a group of photo sensing devices 500, such as TFTs T1˜T6 are coupled to each other in series with the gates coupled to a control line G1, the drains coupled to a control line D1 and the sources coupled to a control line S1. Another group of photo sensing devices 500, such as TFTs T7˜T12, are also coupled to each other in series with the gates coupled to a control line G2, the drains coupled to a control line D2 and the sources coupled to a control line S2. Besides, each photo sensing device 500 can also have a group of individual control lines (G, D, S) to couple with its gate, drain and source for signal control.

Referring to FIG. 2C, a schematic diagram of another example of signal control of the dummy sub-pixels du on the display panel 310 of FIG. 1 is shown. The photo sensing device 500 of each dummy sub-pixel du is a TFT for instance. The photo sensing devices 500 are divided into a number of groups. The gate and drain of each photo sensing device 500 are coupled to each other. Each group of photo sensing devices 500 have their gates (drains) coupled to each other via a first control line and their sources coupled to each other via a second control line. For example, a group of photo sensing devices 500, such as TFTs T1˜T6 are coupled to each other in series with the gates (drains) coupled to a control line A1, and the sources coupled to a control line K1. Another group of photo sensing devices 500, such as TFTs T7˜T12, are also coupled to each other in series with the gates (drains) coupled to a control line A2, and the sources coupled to a control line K2. Besides, each photo sensing device 500 can also have a group of individual control lines (A, K) to couple with its gate (drain) and source for signal control. In this way, the pins for control signals of the display panel 310 can be reduced.

Referring to FIG. 2D, a schematic diagram of another example of signal control of the dummy sub-pixels du on the display panel 310 of FIG. 1 is shown. The photo sensing device 500 of each dummy sub-pixel du is a TFT for instance. The photo sensing devices 500 are divided into a number of groups. Each group of photo sensing devices 500 have their gates coupled to each other via a first control line, their drains coupled to each other via a second control line and their sources coupled to each other via a third control line and the first control line is coupled to the second control line. For example, a group of photo sensing devices 500, such as TFTs T1˜T6 are coupled to each other in series with the gates coupled to a control line G1, the drains coupled to a control line D1 and the sources coupled to a control line S1. The control line G1 is coupled to the control line D1 outside the display panel 310. Another group of photo sensing devices 500, such as TFTs T7˜T12, are also coupled to each other in series with the gates coupled to a control line G2, the drains coupled to a control line D2 and the sources coupled to a control line S2. The control line G2 is coupled to the control line D2 outside the display panel 310. Besides, each of the photo sensing device 500 can also have a group of individual control lines (G, D, S) to couple with its gate, drain and source for signal control and the control lines (G, D) are coupled to each other.

A channel layer of the TFT can be composed of mono-crystalline silicone, polycrystalline silicone (poly-Si) or amorphous silicone (a-Si) for sensing light. Moreover, the photo sensing devices 500 can be electrically coupled to the photo sensing controller 320 respectively or be electrically coupled to the photo sensing controller 320 in group as shown in FIGS. 2B˜2D. The photo sensing controller 320 can be integrated with the data driver SD or the scan driver GD. It should be noted that the photo sensing controller 320 can determine the environmental luminance according to all or a part of the photo sensing signals S1 outputted by the photo sensing devices 500.

In the embodiment, the display panel 310 is a TFT liquid crystal display panel and includes a TFT substrate, a color filter substrate and a liquid crystal layer. The sub-pixels pi and dummy sub-pixels du are disposed on the TFT substrate and the liquid crystal layer is disposed between the TFT substrate and color filter substrate. Generally speaking, the TFT substrate includes an active matrix pixel array with a number of sub-pixels. The sub-pixels located at the edge of the active matrix pixel array of the display panel 310 are designed as dummy sub-pixels du, which are not electrically coupled to the sub-pixels pi for frame display. That is, the sub-pixels pi are driven by the data driver SD and scan driver GD, but not the dummy sub-pixels. According to the concept of the invention, all, a part, or at least one of the dummy sub-pixels du includes a photo sensing device 500 as shown in FIG. 1. The position of the dummy sub-pixel du disposed on the display panel 310 can be adjusted in accordance with requirement of a designer to achieve a more complete light sensing effect. As shown in FIGS. 2A˜2D, the dummy sub-pixels du with the photo sensing devices 500 are disposed at four sides of the active area AA.

In the embodiment, the dummy sub-pixels du with the photo sensing devices 500 can be continuously or discontinuously disposed at three sides of the active area AA. Besides, the dummy sub-pixels du with the photo sensing devices 500 can also be continuously or discontinuously disposed at two adjacent sides or two opposite sides of the active area AA. Or the dummy sub-pixels du with the photo sensing devices 500 can be continuously or discontinuously disposed at one side of the active area M.

The spectrum of sunlight is centered by visible light and has a main distribution range from an ultraviolet ray of 0.3 um to an infrared ray of a few ums, which is equivalent to a photon-energy range from 0.4 eV to 4 eV. When energy of a photon is smaller than band-gap of a semiconductor, the photon will not be absorbed by the semiconductor. At the time, the semiconductor is transparent for the photon. When energy of the photon is larger than the band-gap of the semiconductor, the amount of energy equivalent to the band-gap of the semiconductor will be absorbed by the semiconductor to generate pairs of electrons and electron holes. The remained energy will be released in form of heat. Therefore, band-gap of the material for manufacturing the photo sensing device 500 should be large enough to generate pairs of electrons and electron holes.

Generally speaking, an ideal material for the photo sensing device 500 must have the following features:

1. The material has a band-gap between 1.1 eV and 1.7 eV.

2. It is a direct semiconductor.

3. The material is not poisonous.

The material can be mass-manufactured by a thin-film deposition technique.

5. The material has good efficiency of photoelectric transformation.

The band-gap of silicone is known to be 1.12 eV and is the second richest element on earth. Therefore, it is preferably used as a material for a photo sensing device. Besides, the silicone atom can be classified into mono-crystalline silicone, poly-crystalline silicone (poly-Si) and amorphous silicone (a-Si) in terms of a crystallization pattern. The mono-crystalline silicone and poly-Si have higher and stable efficiency of photoelectric transformation and the a-Si has larger light absorption ability than silicone by 500 times. Therefore, a thin layer of a-Si can effectively absorb photon energy, and a-Si can be deposited in a large area and low temperature on a cheaper substrate made of, such as glass, ceramics or metal, which helps to reduce material cost.

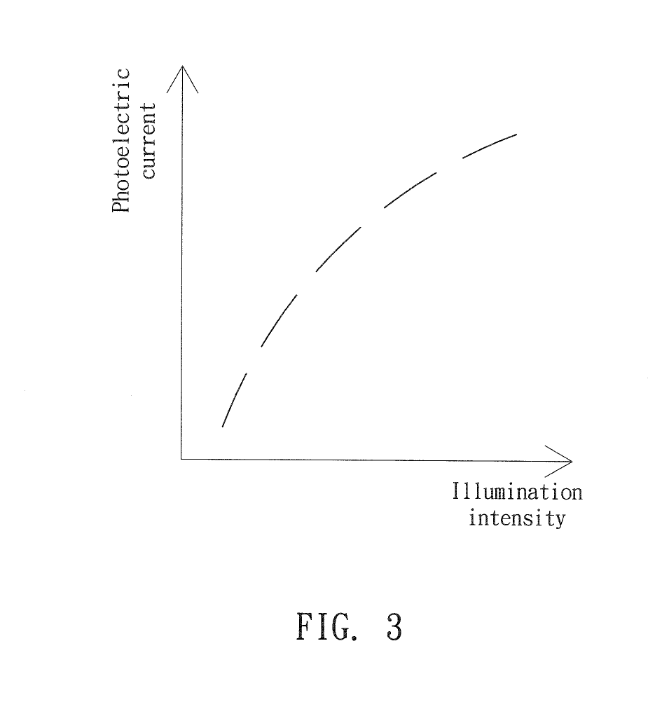

When the a-Si material is illuminated to generate pairs of electrons and electron holes, a recombination effect due to illumination provides a large amount of moving carriers to improve its photo-conductivity. Referring to FIG. 3, a relationship diagram of illumination intensity and photoelectric current is shown. Normally, photo-conductivity due to illumination is directly proportional to the illumination intensity, that is, the more intense the illumination is, the larger the photo-conductivity becomes. For this reason, a a-Si TFT is used as a main photo sensing device in the invention, but the invention is not limited thereto and can also use a substrate of poly-Si or mono-crystalline silicone for designing the photo sensing device.

According to the invention, when a-Si is used for forming the channel layer of the photo sensing device 500, although it has a quite sensible light receiving feature, a width/length ratio WIL of the device 500 should be increased so as to supply enough large current for system application due to a low carrier moving rate (about 0.5˜1 cm²/V-s) of the a-Si TFT.

For example, if the display panel 310 has a resolution 176*RGB*220 (like a 1.9 inch panel) and the photo sensing device 500 configured in each dummy sub-pixel has a WIL value equal to 300/5, there are totally (176*3+2)*2+220*2=1,500 dummy sub-pixels and the designable maximum WIL value of all the photo sensing devices 500 is (1,500*300)/5=450,000/5.

The displays disclosed by the patents U.S. Pat. No. 5,831,693 and TW575849 have a dot-like distribution in pixels and require openings for the photo sensing devices to receive light from outside, which increases a layout area for photo sensing devices as well as an opening area of an outer covering, thereby reducing artistic appearance of the panel. Therefore, the invention can not only prevent reduction of artistic appearance of the panel due to an overlarge opening area, but also have a more complete light receiving angle by using a rod-like layout to effectively enhance light sensing efficiency, which is very different from the dot-like photo sensing design in the patents U.S. Pat. No. 5,831,693 and TW575849. Besides, the photo sensing devices in the invention is positioned at the edge of the active area and thus the panel-edge size and layout complication can be reduced.

As compared to the Japanese patent No. 11-125841, in the invention, the dummy sub-pixels of the active area are used for designing control signal lines, which has no issue of wiring layout complication in the active area and thus has less influence on display data of sub-pixels for displaying frames in the active area.

As shown in the embodiment of FIG. 1, the photo sensing devices 500 can be driven as a whole or respectively by the photo sensing controller 320. Or a few photo sensing devices 500 are driven by one photo sensing controller 320. In practical application, the photo sensing controller 320 can be integrated with the data driver SD or scan driver GD or the photo sensing controller 320, data driver SD and scan driver GD can be an integrated controller. All these are not apart from the scope of the invention.

The photo sensing display apparatus and display panel thereof disclosed by the above embodiment of the invention is designed to include photo sensing devices in dummy sub-pixels of the active area. By doing this, it can prevent reduction of artistic appearance due to an overlarge opening area, have more complete light receiving angle by using a rod-like layout and thus higher photo sensing efficiency. Besides, photo sensing devices are positioned at the edge of the active area, which reduces panel edge size and layout complication and has less influence on display data of sub-pixels in the active area. The photo sensing devices are integrated with the display apparatus in an original manufacturing process, which increases an added value of a portable electronic apparatus such as a mobile phone or personal digital assistant. Moreover, a photo sensing layout can be designed to fit in various driver applications to reduce loss of signal transmission.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A photo sensing display apparatus, comprising:
a display panel, comprising:
an active area;
an inactive area, disposed around the active area;
a plurality of sub-pixels, disposed in the active area for displaying a frame; and
at least a dummy sub-pixel, disposed in the active area, the dummy sub-pixel having a photo sensing device; and
a photo sensing controller, coupled to the photo sensing device.

2. The apparatus according to claim 1, wherein the display panel comprises a plurality of dummy sub-pixels, the photo sensing devices of the dummy sub-pixels are coupled to each other in series and electrically coupled to the photo sensing controller via at least two control lines.

3. The apparatus according to claim 2, wherein the photo sensing devices are thin film transistors (TFTs), which are coupled to each other in series with the gates as well as drains of the TFTs coupled to one of the control lines and the sources of the TFTs coupled to the other control line.

4. The apparatus according to claim 2, wherein the photo sensing devices are thin film transistors (TFTs), which are coupled to each other in series with the gates of the TFTs coupled to a first control line, the drains of the TFTs coupled to a second control line, the sources of the TFTs coupled to a third control line, and the three control lines electrically connecting the photo sensing controller and the TFTs.

5. The apparatus according to claim 4, wherein the first control line is coupled to the second control line.

6. The apparatus according to claim 1, wherein the display panel comprises a plurality of dummy sub-pixels and the photo sensing devices of the dummy sub-pixels are electrically coupled to the photo sensing controller respectively.

7. The apparatus according to claim 1, wherein the display panel comprises a plurality of dummy sub-pixels and the photo sensing devices of the dummy sub-pixels are electrically coupled to the photo sensing controller in group.

8. The apparatus according to claim 1, wherein the display panel comprises a plurality of dummy sub-pixels and the dummy sub-pixels are continuously or discontinuously disposed at four sides of the active area.

9. The apparatus according to claim 1, wherein the display panel comprises a plurality of dummy sub-pixels and the dummy sub-pixels are continuously or discontinuously disposed at three sides of the active area.

10. The apparatus according to claim 1, wherein the active area comprises a plurality of dummy sub-pixels and the dummy sub-pixels are continuously or discontinuously disposed at two sides of the active area.

11. The apparatus according to claim 1, wherein the display panel comprises a plurality of dummy sub-pixels and the dummy sub-pixels are continuously or discontinuously disposed at one side of the active area.

12. The apparatus according to claim 1, wherein the photo sensing device is a thin film transistor (TFT) and a channel layer of the TFT is composed of mono-crystalline silicone.

13. The apparatus according to claim 1, wherein the photo sensing device is a thin film transistor and a channel layer of the thin film transistor is composed of polycrystalline silicone (poly-Si).

14. The apparatus according to claim 1, wherein the photo sensing device is a TFT and a channel layer of the TFT is composed of amorphous silicone (a-Si).

15. The apparatus according to 1, wherein the display panel further comprises a TFT substrate, a color filter substrate and a liquid crystal layer, the liquid crystal layer is disposed between the TFT substrate and the color filter substrate and the sub-pixels and the dummy sub-pixel are disposed on the TFT substrate.

16. A display panel, capable of sensing environmental luminance and electrically coupled to a photo sensing controller, the display panel comprising:
an active area;
an inactive area, disposed around the active area;
a plurality of sub-pixels, disposed in the active area for displaying a frame; and
at least a dummy sub-pixel, disposed in the active area, the dummy sub-pixel having a photo sensing device for sensing the environmental luminance and outputting a photo sensing signal to the photo sensing controller.

17. The display panel according to claim 16, comprising a plurality of dummy sub-pixels, wherein the photo sensing devices of the dummy sub-pixels are coupled to each other in series and electrically coupled to the photo sensing controller.

18. The display panel according to claim 16, comprising a plurality of dummy sub-pixels, wherein the photo sensing devices of the dummy sub-pixels are electrically coupled to the photo sensing controller respectively.

19. The display panel according to claim 16, comprising a plurality of dummy sub-pixels, wherein the photo sensing devices of the dummy sub-pixels are electrically coupled to the photo sensing controller in group.

20. The display panel according to claim 16, comprising a plurality of dummy sub-pixels, wherein the dummy sub-pixels are continuously or discontinuously disposed at four sides of the active area.

21. The display panel according to claim 16, comprising a plurality of dummy sub-pixels, wherein the dummy sub-pixels are continuously or discontinuously disposed at three sides of the active area.

22. The display panel according to claim 16, comprising a plurality of dummy sub-pixels, wherein the dummy sub-pixels are continuously or discontinuously disposed at two sides of the active area.

23. The display panel according to claim 16, comprising a plurality of dummy sub-pixels, wherein the dummy sub-pixels are continuously or discontinuously disposed at one side of the active area.

24. The display panel according to claim 16, further comprising a TFT substrate, a color filter substrate and a liquid crystal layer, wherein the liquid crystal layer is disposed between the TFT substrate and the color filter substrate and the sub-pixels and the dummy sub-pixel are disposed on the TFT substrate.
